(19) United States
(12) Patent Application Publication
(10) Pub. No.: US 2013/0021872 A1
(43) Pub. Date: Jan. 24, 2013

(54) SEISMIC EXPLORATION NOISE REDUCTION DEVICE

(71) Applicants: VIDAR A. HUSOM, ASKER (NO); NICOLAS GOUJON, OSLO (NO)

(72) Inventors: VIDAR A. HUSOM, ASKER (NO); NICOLAS GOUJON, OSLO (NO)

(21) Appl. No.: 13/439,988

(22) Filed: Apr. 5, 2012

Related U.S. Application Data
(60) Provisional application No. 61/473,254, filed on Apr. 8, 2011.

(51) Int. Cl. G01V 1/38

(52) U.S. Cl. 367/16

(57) ABSTRACT

A marine seismic exploration device includes a vessel; a sensor device on the vessel that senses movement of the vessel; a connection device that comprises an electric motor; a controller that communicates with the sensor device and the motor; and a seismic sensor connected with the connection device. The connection device has at least a first position where the connection device extends a first length and a second position where the connection device extends a second length, wherein the second length is longer than the first length. The controller is programmed to compensate for the movement of the vessel detected by the sensor by moving the connection device between positions to control the length that the connection device extends.

### CROSS-REFERENCE TO RELATED APPLICATION

This applications claims benefit of U.S. Provisional Patent Application No. 61/473254 filed on Apr. 8, 2011, which is incorporated herein by reference.

### TECHNICAL FIELD

The present disclosure relates to marine seismic exploration. More specifically, the present disclosure relates to noise reduction for marine seismic exploration.

### BACKGROUND

Seismic exploration involves surveying subterranean geological formations for hydrocarbon deposits. A seismic survey typically involves deploying seismic source(s) and seismic sensor(s) at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and surveys may deploy only one type of sensor or both. Accelerometers may also be used to sense motion. In response to the detected seismic events, the sensors generate electrical signals to produce seismic data. Analysis of the seismic data can then indicate the presence or absence of probable locations of hydrocarbon deposits or other valuable materials.

Marine seismic exploration involves the same in a marine environment. Sources produce seismic waves that propagate through the water and into the seafloor and reflect up. Those seismic waves are similarly received and kept as data, which is analyzed to produce information about the seabed geology.

In both land and marine exploration, it is desirable to minimize “noise” that the seismic sensors receive and that becomes part of the received data. Accordingly, there are numerous situations where the issue of “noise” is present and can be addressed. The present disclosure addresses various issues relating to “noise” in marine seismic exploration.

### SUMMARY

The following summary is meant to provide a brief description of various embodiments and is not meant in any way to unduly limit any present or future related claims.

According to an embodiment, a marine seismic exploration device includes a vessel; a sensor device on the vessel that senses movement of the vessel; a connection device that comprises an electric motor; a controller that communicates with the sensor device and the motor; and a seismic sensor connected with the connection device. The connection device has at least a first position where the connection device extends a first length and a second position where the connection device extends a second length, wherein the second length is longer than the first length. The controller is programmed to compensate for the movement of the vessel detected by the sensor by moving the connection device between positions to control the length that the connection device extends.

According to another embodiment, a marine seismic exploration device includes a floating hull and a propulsion device connected to the floating hull. The propulsion device comprising wings, at least portions of the wings rotation about an axis thereby changing angle with respect to upward or downward movement of the propulsion device in water to produce forward thrust.

### DESCRIPTION OF THE DRAWINGS

The following description of the drawings is meant to assist one skilled in the art to understand various disclosed features of embodiments herein. It is not meant to unduly limit any present or future related claims.

FIG. 1 shows a side view schematic.

FIG. 2 shows a side view of a portion of a thrust device.

FIG. 3 shows a side view of a reel with a motor.

FIG. 4 shows a side view schematic of a reel with a spring.

FIG. 5 shows a side view schematic of a portion of a streamer.

FIG. 6 shows a side view schematic.

FIG. 7 shows a side view of an embodiment with an underwater vessel.

FIG. 8 shows an embodiment with a piston.

FIG. 9 shows a lever embodiment.

### DETAILED DESCRIPTION

The following detailed description relates to a number of combinations of features of various embodiments. It is to be understood that the description is non-limiting and is meant to assist one skilled in the art to understand the subject matter at hand. The description is not meant to unduly limit the scope of any present or future related claims.

Marine seismic exploration generally involves providing a source of seismic energy that travels into the earth and reflects. This source can be an air gun or a vibrator. Also, explosives can be used. Also, one can detect passive seismic energy, e.g., earthquakes and other naturally occurring seismic signals. The reflections can be detected by seismic sensors to provide data in the form of electrical or optical signals. This data can be processed to derive information about the geology at hand. For example, one can determine the presence (or absence) of hydrocarbons, or other valuable information.

One way to detect the seismic reflections is with various seismic sensors such as hydrophones, geophones and/or accelerometers. These sensors can be incorporated into a long and flexible tubular body known as a “streamer.” The streamer can be towed behind a vessel. The streamer can be near the water's surface or farther below the surface. The streamers can receive the seismic reflections and convert the reflections to electric signals. The electric signals can be processed on the streamer by local processors and/or transmitted to a processor and storage unit on the vessel. This transmission can be by way of wire or wireless communication signal. Streamers are available commercially.

Streamers can be towed by vessels (ships). These vessels are generally powered by large internal combustion engines. These ships are generally relatively large and weigh thousands of tons. The ship's size and power can be large when numerous long streamers are towed. The streamers can be multiple kilometers long in that case.

Streamers can also be towed by smaller vessels. In that case, the streamer's size can be proportionally smaller, fewer in number, and as few as a single streamer. In cases where a vessel tows a single streamer, multiple vessels can be used in coordination to provide a series of streamers for a survey. Similarly, the smaller size of the towing vessel enhances the effect that the ocean's movements have on the vessel and in turn the streamer. Also, variations in propulsion of the vessel will have greater effect on the vessel and in turn the streamer. This is the case with motorized vessels, wave propulsions, and vessels powered by sail. This is especially the case with vessels that are powered by wave movement or wind.

Streamers in general are susceptible to noise created by uneven or unstable water flow, shock and vibration. Noise can be created by unstable water flow down the streamer (caused by barnacles, seaweed and such), inconsistent flow down the streamer (caused by change in towing speed), flow perpendicular to the streamer (caused by rise and fall of the streamer in the water often due to movement of the towing vessel), and by shock and or vibration (caused by change in movement/position of the towing vessel in a horizontal and/or vertical direction). When the vessel speeds up or slows down, a shock can be sent through the streamer that causes noise. Also, when a vessel raises or lowers due to waves the level of the streamer can change (causing transverse flow) and the streamer experiences shock and/or vibration.

These issues can be present in streamer towing situations, but are much more pronounced when small vessels and correspondingly small streamers are involved. This is especially the case with small autonomous unmanned vessels (AUV's).

One way to address this issue is with the use of an elastic member located between the towing vessel and the streamer. This helps absorb the various shocks and also reduces the movement of the streamer in relation to the towing vessel. The elastic effect can be realized by use of an elastic member such as a rubber part that stretches, or a spring device can be used.

Another way to produce an effect is by providing a connection device between the vessel and the streamer that changes its length (lets out or brings in) to compensate for movement of the vessel and the resulting noise (from shock and flow) received by the streamer. The velocity that the length is let out or taken in can be controlled. Also, the acceleration that the length is let out or taken in can be controlled. For example, if the tow vessel accelerates forward in the water, the length can be let out to compensate and reduce and shock felt by the streamer. Similarly, if the vessel rises on a wave the length can be let out to compensate. If the vessel slows the length can be taken in to compensate. If the vessel drops on a wave the length can be taken in. These are but a few examples and are not to be understood as being exhaustive or limiting with respect to the various ways in which the length can be controlled to compensate for vessel movement and reduce resulting noise sensed by the streamer.

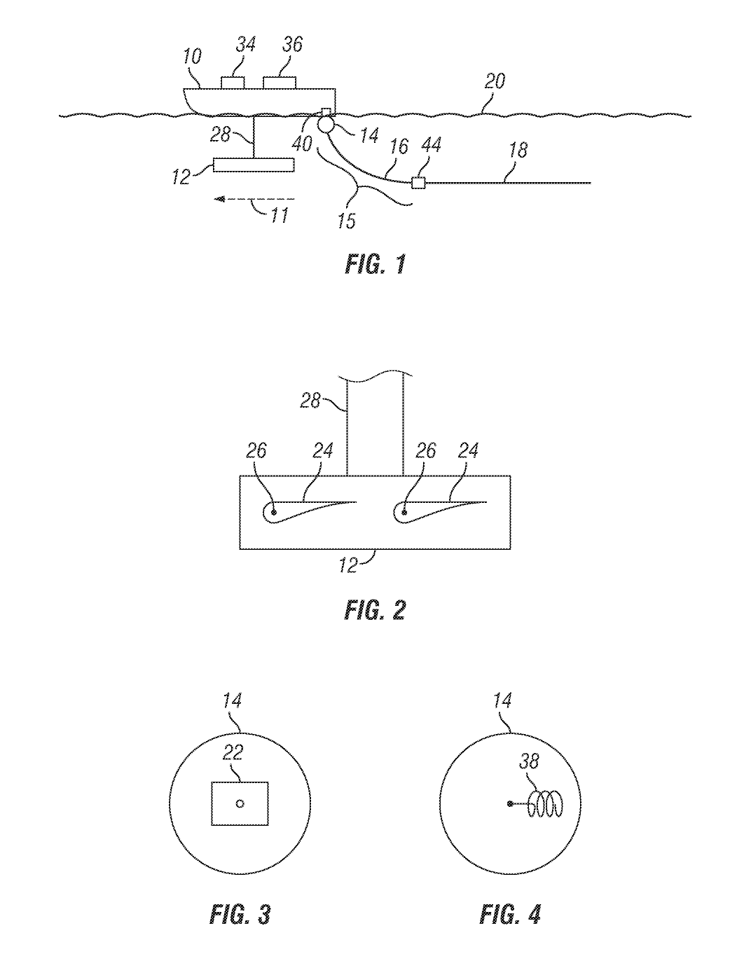

FIG. 1 shows a side view of an embodiment where a vessel 10 is on the surface of the water 20. The vessel 10 can have a rudder or other steering device. The vessel 10 can be autonomous and unmanned. An autonomous vessel 10 can be set with pre-defined instructions for travel or operation. Also, the vessel 10 can be controlled by wireless communication and can be intermittently updated with instructions and information. Or, the vessel 10 can be continuously controlled wirelessly or remotely by wire. Further, the vessel 10 can be manned in various embodiments. The vessel 10 can be powered (electric or gas motor). In the case of electric power, a battery can be located on the vessel 10, solar panels can be placed on the vessel 10 to provide power and/or a power harvester can be used to harvest power from the ocean movement or wind movement. The vessel 10 can also be propelled by a wave powered propulsion device (“wave-glider”) 12. An embodiment of a wave-glider 12 includes at least one fin 24 that is connected to the wave-glider 12 body. At least a portion of the fin 24 rotates about an axis 26 so that when the wave-glider 12 moves up, the fin 24 angles downward and produces thrust for the vessel 10 in a forward direction 11. Conversely, when the wave-glider 12 moves down in the water, the fin 24 angles upward, and produces thrust for the vessel 10 in the forward direction 11. The fin 24 can be flexible and have a portion of the fin 24 angle. The fin 24 can also be stiff and have rotatable connection with the wave-glider 12 body and operate in a similar manner. The fin 24 can also be both flexible and also have rotatable connection. A support structure 28 connects the wave-glider 12 to the vessel 10. The structure can be rigid or flexible. When the structure 28 is flexible, the wave-glider 12 should be weighted so as to sink when not pulled to surface. Wave-gliders and similar devices are commercially and an embodiment of such is disclosed in U.S. Pat. No. 7,371,136, which is incorporated herein in its entirety.

The vessel 10 can also be propelled by sail (e.g., a rigid sail).

FIG. 1 shows a connection device 15 comprising a flexible member 16 and a reel 14. The flexible member 16 connects with a streamer 18. At least part of the flexible member 16 is wrapped around the reel 14. The reel 14 has a first rotational position where a first length of the flexible member 16 extends from the reel 14 and is a certain length. At a second rotational position of the reel 14 a second length of the flexible member 16 extends from the reel 14 a distance from the vessel 10, the second length being longer than the first length.

The flexible member 16 can be a cable and can have signal conduits incorporated therein to transfer data and/or signals from the streamer 18 to the vessel 10.

According to an embodiment, as shown in FIG. 3, a motor 22 can be connected with the reel 14. The motor can be controlled by a processor 34 that is located on the vessel 10. The motor 22 can be electric and can be a servo motor. The controller can use sensors 36 to detect movement of the vessel 10. The sensors 36 can include accelerometers, velocity measurement devices, global positioning devices and rotation sensors to detect movement of the vessel 10. Based on the signals received from the sensors 36 the controller 34 can extend or retract the reel 14 and in turn adjust the length of the flexible member 16 to compensate for the movement of the vessel 10 and minimize the shock/noise experienced by the streamer 18.

The reel 14 can have a spring 38 connected that biases the reel 14 to rotate in one direction. The spring 14 will operate to dampen/reduce shocks or movement from the vessel 10 to the streamer 18 thereby reducing noise.

Similarly, instead of a reel 14, or in addition to a reel 14, an elastic member 40 can be connected between a portion of the flexible member 16 and the vessel 10.

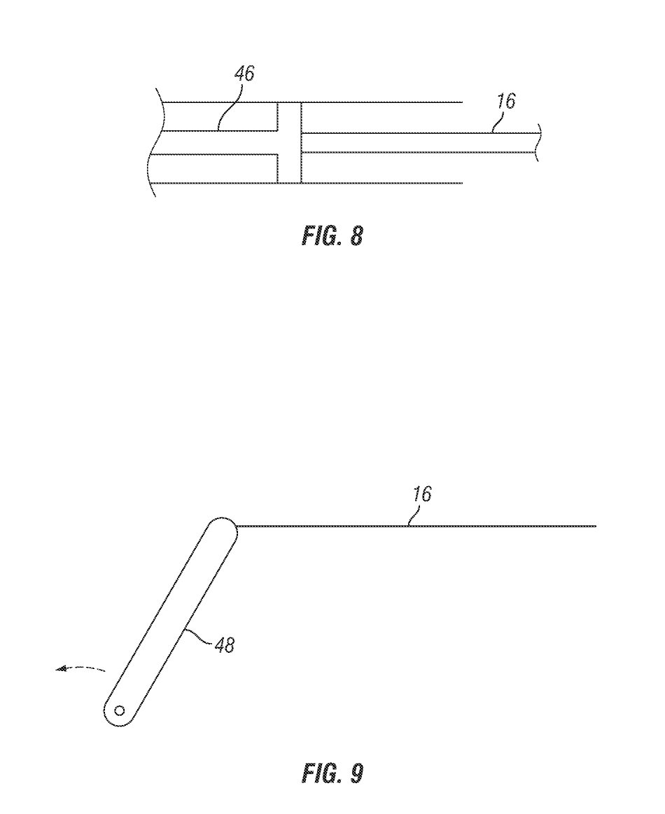

Also, a device other than a reel 14 can be used to extend and retract the flexible member 16. For example, as shown in FIG. 8, a piston 46 could be used to apply linear motion to the flexible member 16. Also, as shown in FIG. 9, instead of a reel 14 rotating, a lever arm 48 could rotate about a point with one end and connect with the flexible member with the other end to control the extension of the flexible member. Other rotating arm configurations are possible.

It should be understood that the connection device 15 can connected between the vessel 10 and the streamer in any manner. FIG. 6 shows that another member 42 could connect from the vessel to the reel 14 of the connection device 15.

FIG. 1 shows a weight 44 known as a “towfish.” The weight 44 helps to keep the streamer 18 at a certain depth.

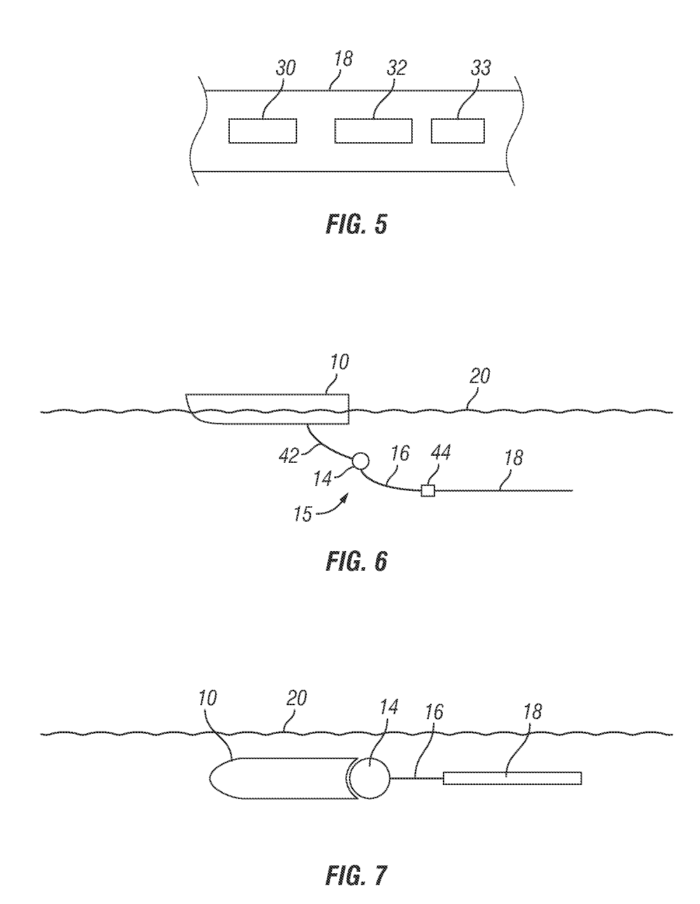

FIG. 5 shows a portion of the streamer 18 including a hydrophone 30, geophone 32 and an accelerometer 33.

It should be understood that the vessel 10 does not need to float on the surface. The vessel 10 can travel underwater. FIG. 7 shows such a configuration. In the case of an underwater vessel 10, the connection device 15 operates in the same manner as with the surface vessel 10.

With respect to compensation, as shown in FIG. 3, an electric motor 22 can control the movement of the reel 14. The motor 22 can be controlled by the controller 34 on the vessel 10. This control can be done with signals over wired communication or wireless communication. The controller 22 can receive information from sensors 36 on the vessel relating to movement/position of the vessel 10. If the vessel 10 accelerates forward, the controller 34 can instruct the motor 22 to rotate the reel 14 to let out the flexible member 16 to compensate. Conversely, if the vessel 10 slows the controller 34 can instruct the motor 22 to rotate the reel 14 to take in the flexible member 16 to compensate. The rotational position of the reel 14 can be controlled to control the length that the flexible member 16 is let out. The rotational velocity of the reel 14 can be controlled to control the velocity at which the flexible member is taken in or let out. The rotational acceleration of the reel 14 can be controlled to control the acceleration at which the flexible member 16 is let out or taken in.

The embodiments described herein are meant to help one skilled in the art understand various embodiments. The disclosure herein is not meant in any way to unduly limit any present or future related claims.

What is claimed is:

1. A marine seismic exploration device, comprising:
a vessel;
a sensor device on the vessel that senses movement of the vessel;
a connection device that comprises an electric motor;
a controller that communicates with the sensor device and the motor;
a seismic sensor connected with the connection device; wherein
the connection device has at least a first position where the connection device extends a first length and a second position where the connection device extends a second length, wherein the second length is longer than the first length; and
the controller being programmed to compensate for the movement of the vessel detected by the sensor by moving the connection device between positions to control the length that the connection device extends.

2. The marine seismic exploration device of claim 1, wherein the connection device comprises a flexible member.

3. The marine seismic exploration device of claim 2, wherein the connection device comprises a reel, a portion of the flexible member being wrapped around the reel.

4. The marine seismic exploration device of claim 3, wherein rotational velocity of the reel is controlled by a motor and a controller to compensate for movement of the vessel.

5. The marine seismic exploration device of claim 1, wherein the acceleration of the movement between positions is controlled to compensate for movement of the vessel.

6. The marine seismic exploration device of claim 4, wherein rotational acceleration of the reel is controlled to compensate for movement of the vessel.

7. The marine seismic exploration device of claim 2, wherein the connection device is connected to the vessel by a support member.

8. The marine seismic exploration device of claim 7, wherein the support member is a rigid member.

9. The marine seismic exploration device of claim 7, wherein the support member is a flexible member.

10. The marine seismic exploration device of claim 1, wherein the sensor device senses acceleration of the vessel.

11. The marine seismic exploration device of claim 1, wherein the sensor device senses velocity of the vessel.

12. A marine seismic exploration device, comprising a floating hull and a propulsion device connected to the floating hull;
the propulsion device comprising wings, at least portions of the wings rotation about an axis thereby changing angle with respect to upward or downward movement of the propulsion device in water to produce forward thrust.

13. The marine seismic exploration device of claim 1, wherein the vessel is motorized.

14. The marine seismic exploration device of claim 1, wherein the vessel is autonomous.

15. The marine seismic exploration device of claim 14, wherein the vessel is un-manned.

16. A method of minimizing noise when operating a marine seismic exploration device, comprising:
controlling rate of a change in length of a support member that extends from a vessel to a seismic sensor, to compensate for movement of the vessel.

17. The method of claim 16, wherein the rate of change is the velocity at which the length changes.

18. The method of claim 16, wherein the rate of change is the acceleration at which the length changes.

19. The method of claim 16, wherein the controlling comprises controlling rotational velocity of a reel that the support member is wrapped around.

20. The method of claim 16, comprising changing the rotational acceleration of a reel to control the length of the support in reaction to an acceleration of the vessel.

21. The method of claim 16, comprising a streamer that houses the seismic sensor, the streamer being connected to the support member.

22. The marine seismic exploration device of claim 1, wherein the connection device comprises a piston.
